(19) United States
(12) Patent Application Publication
(10) Pub. No.: US 2014/0209532 A1
(43) Pub. Date: Jul. 31, 2014

(54) OIL FILTRATION SYSTEM

(71) Applicants: Gust C. Kepler, Dallas, TX (US); Stanley Ray Abbott, Dallas, TX (US)

(72) Inventors: Gust C. Kepler, Dallas, TX (US); Stanley Ray Abbott, Dallas, TX (US)

(21) Appl. No.: 14/167,921

(22) Filed: Jan. 29, 2014

Related U.S. Application Data
(60) Provisional application No. 61/758,094, filed on Jan. 29, 2013.

(51) Int. Cl. B01D 35/00

(52) U.S. Cl. CPC B01D 35/005
USPC 210/435

(57) ABSTRACT

According to one embodiment, a bypass oil filter and a filtration element for oil filtration. The housing has an inlet and an outlet and is configured to provide a flow path for oil from the inlet to the outlet. The filtration element includes multiple filtration segments arranged in series configuration with one another along the flow path in which each filtration segment having a filtering density that is greater than the filtering density of another filtration segment upstream along the flow path.

### CROSS-REFERENCE TO RELATED APPLICATION(S) AND CLAIM OF PRIORITY

The present application claims priority to U.S. Provisional Patent Application Ser. No. 61/758,094, filed Jan. 29, 2013, entitled “OIL FILTRATION SYSTEM”.

### TECHNICAL FIELD

The content of the above-identified patent document is incorporated herein by reference. This disclosure relates generally to mechanical devices, and more particularly, to an oil filtration system.

### BACKGROUND

Early automobile engines did not use oil filters. For this reason, along with the generally low quality of oil available, frequent oil changes were often required. The first oil filters were simple, generally consisting of a screen placed at the oil pump intake.

### SUMMARY

According to one embodiment, a bypass oil filter and a filtration element for oil filtration. The housing has an inlet and an outlet and is configured to provide a flow path for oil from the inlet to the outlet. The filtration element includes multiple filtration segments arranged in series configuration with one another along the flow path in which each filtration segment has a filtering density that is greater than the density of another filtration segment upstream along the flow path.

Certain embodiments may provide various technical advantages depending on the implementation. For example, oil filters typically used with petroleum and diesel fueled engines are generally located near the middle or bottom of the engine. Clean, dry oil can extend engine life between failures up to 8-10 times the normal operating life of the engine. In some cases, reducing water levels from 100 ppm to 25 ppm can increase bearing life by as much as a factor of two. Additionally, if solids contamination with particles larger than 5 micron is reduced from a range of 5000-10,000 particles/ml of oil to 160-320 particles, machine life can be increased as much as five times. Therefore, a benefit to be gained in having clean oil and monetary expense incurred in achieving this goal may, in many cases, yield a positive return. Particularly, where relatively costly expensive equipment is used and the cost of maintenance is high or where the equipment is costly but not highly profitable to operate. Increasing the equipment life and the period between maintenance up to 10 times normal would be highly profitable in both cases. Certain embodiments of the filtration system described herein may provide a solution to this problem by providing enhanced filtration of oil used in engines.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate an example oil filtration system according to embodiments of the present disclosure; and

FIGS. 3 through 5 illustrate an example filtration element including multiple filtration segments according to embodiments of the present disclosure.

### DETAILED DESCRIPTION

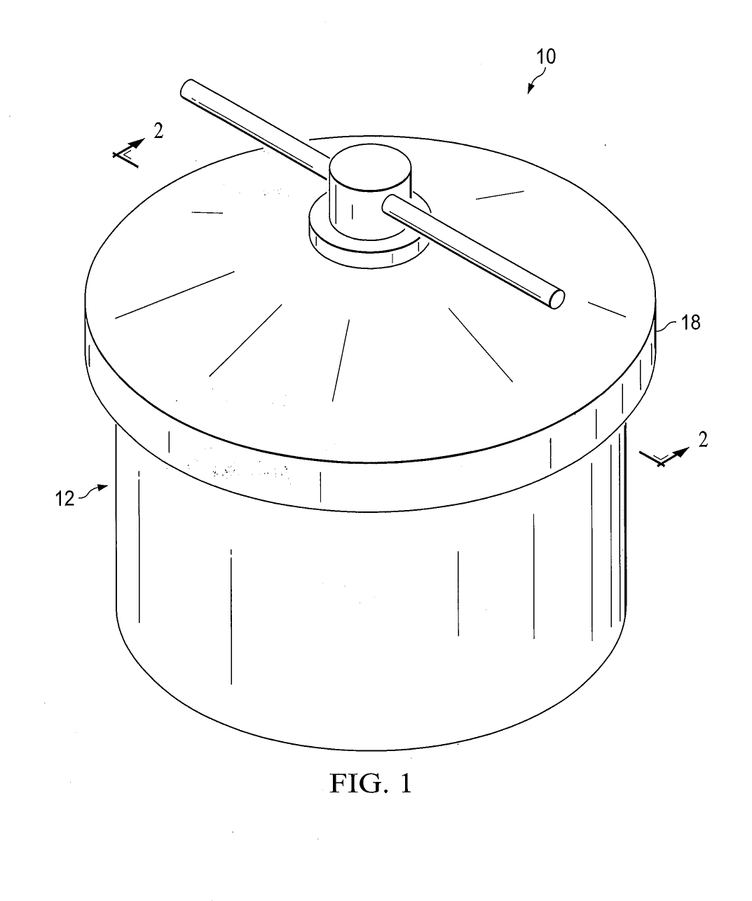

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device(s) or system(s).

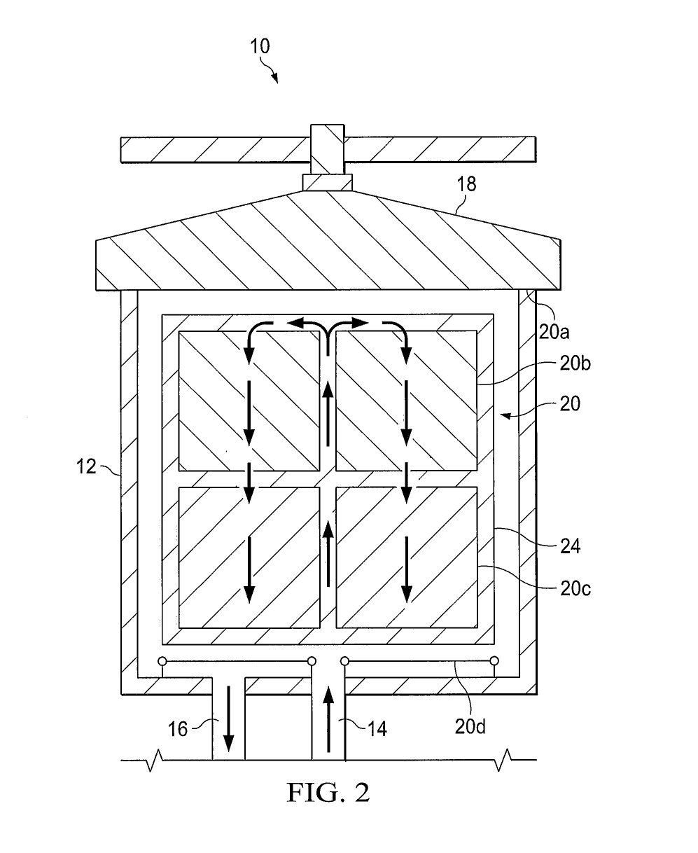

FIGS. 1 and 2 illustrate an example oil filtration system 10 according to embodiments of the present disclosure. Although “oil” will be described as being filtered in particular embodiments, it should be expressly understood that other types of fluids may also be filtered, using features of the present disclosure.

Oil filtration system 10 includes a housing 12 having an inlet 14 and an outlet 16, and a filtration element 20 that is housed in the housing 12. The filtration system 10 shown in FIGS. 1 and 2 is sometimes referred to as a “bypass” filter. However, one of ordinary skill in the art may apply teachings of the present disclosure to other filter designs, including non-bypass filters.

In operation, the housing 12 forms a flow path from the inlet 14 to the outlet 16. As will be described in detail below, the filtration element 20 includes a plurality of filtration segments arranged in series configuration with one another along the flow path. Each filtration segment has a filtering density that is greater than the density of another filtration segment upstream along the flow path.

The housing 12 includes a detachable lid 18 that may be selectively removed for inspection and/or replacement of the filtration element on a periodic, ongoing basis.

In the particular embodiment shown, the filtration element 20 includes four filtration segments 20a, 20b, 20c, and 20d. In other embodiments, the filtration element may include less than four, or greater than four filtration segments. Each filtration segments has a filtration density that increases along the flow path of the oil during operation. In this manner, the oil (or other fluid) may be progressively cleansed of particles, such as dirt, dust, or debris as it flows through the filtration system 10.

Oil filters typically used with petroleum and diesel fueled engines are generally located near the middle or bottom of the engine. Clean, dry oil can extend engine life between failures up to 8-10 times the normal operating life of the engine. In some cases, reducing water levels from 100 ppm to 25 ppm can increase bearing life by as much as a factor of two. Additionally, if solids contamination with particles larger than 5 micron is reduced from a range of 5000-10,000 particles/ml of oil to 160-320 particles, machine life can be increased as much as five times. Therefore, a benefit to be gained in having clean oil and monetary expense incurred in achieving this goal may, in many cases, yield a positive return. Particularly, where relatively costly expensive equipment is used and the cost of maintenance is high or where the equipment is costly but not highly profitable to operate. Increasing the equipment life and the period between maintenance up to 10 times normal would be highly profitable in both cases. Certain embodiments of the filtration system 10 described herein may provide a solution to this problem by providing enhanced filtration of oil used in engines.

Although the oil filter is described as being located near the middle or bottom of the engine, in other configurations, the oil filter may be located at any suitable location, including that those are remote to the engine itself. In such remote oil filter designs, any suitable system may be used to transport oil to and from the oil filter.

To keep the oil traveling in respective designated paths in the housing 16 between inlet 14 and 16, any suitable sealing designs may be utilized. For example, although not expressly shown in FIG. 2, a conduit may be provided with a generally non-permeable material for the flow upward from inlet 14 (the bypass of the filter). Additionally, where such conduit is removable, the floor of the housing 16 may include suitable lips or seats upon which the conduit may sealably rest. Yet other suitable sealing mechanisms—some of which are described below—may also be utilized. Such suitable sealing system should become apparent to one of ordinary skill in the art after review of the present specification.

Although a single pass configuration after a bypass is shown in this configuration, in other configurations, a dual pass configuration may be utilized. For example, in such a dual pass configuration oil enters and exits through the same side, traversing through one layer of filters and then another layer of filters. The same principles of increasing the respective filtration can be maintained exit by having separate two annular compartments—one with a flow from top to bottom and another with a flow from bottom to top. Looking at FIG. 2, the currently shown design could be an inner annular compartment. Another annular compartment may be added to outside for another filtration pass and exiting through the top. In other words, instead of exiting outlet 16, the oil would travel through another pass upward through another pass. The same principal may additionally be utilized for yet other passes (e.g., three passes or more).

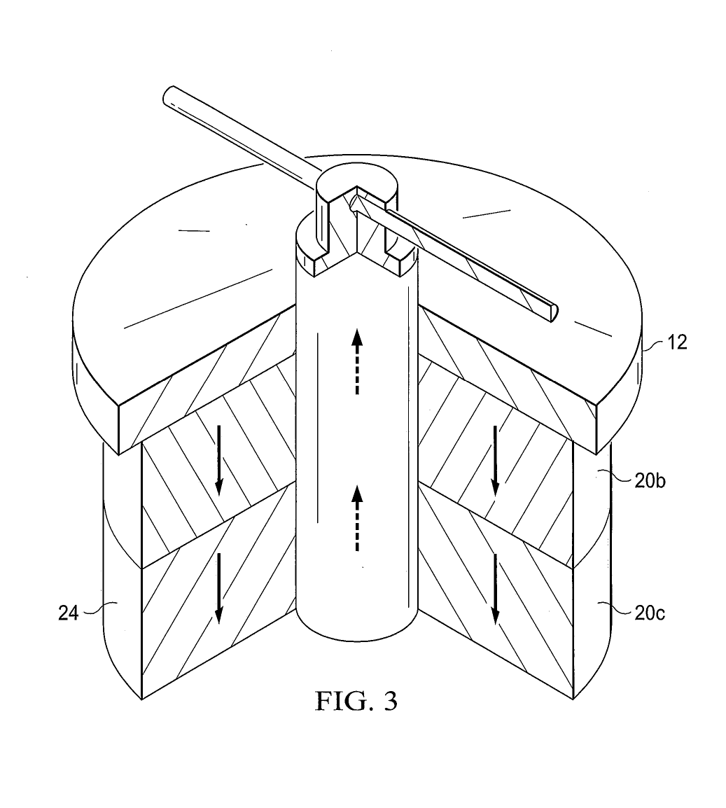

FIGS. 3 through 5 illustrate an example filtration element 20 including multiple filtration segments according to embodiments of the present disclosure.

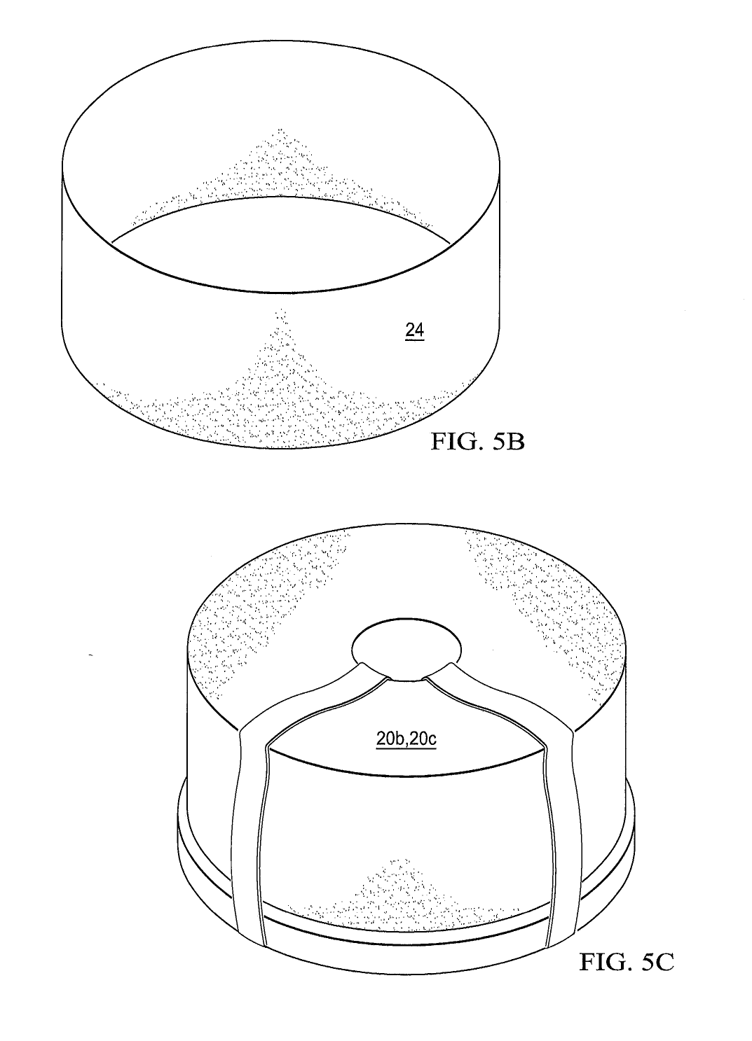

The first filtration segment 20a generally includes a single sheet of non-woven material. The first filtration segment 20a (e.g., seen in FIG. 5) has the lowest filtration density for trapping the largest particles that may be suspended in the oil. For example, the first filtration segment 20a may have a filtration density for trapping relatively large suspended particles such as metallic particles caused due to engine wear, or larger particles of dirt that have entered the oil via the combustion chamber of the engine.

The second filtration segment 20b (e.g., seen in FIGS. 3 and 5) is the second to filter the oil along the flow path. The second filtration segment 20b has a higher filtering density than the first filtration segment 20a for trapping particles not trapped by the first filtration segment 20a. The second filtration segment 20b is generally made of an elongated sheet of non-woven material wound into a roll-like form.

The third filtration segment 20c (e.g., seen in FIGS. 3 and 5) is arranged downstream of the second filtration segment 20b and has a higher filtration density than the second filtration segment 20b. Like the second filtration segment 20b, the third filtration segment 20c is made of an elongated sheet of non-woven material wound into a roll-like form. The non-woven material used to make the third filtration segment, however, has a tighter woven membrane structure than the second filtration segment 20b to trap smaller particles suspended in the oil not trapped by the second filtration segment 20b.

In one embodiment, the first, second, and third filtration segments 20a, 20b, and 20c may be configured as a one piece structure such that they may be replaceable as a single unit. That is, the second and third filtration segments 20b and 20c may be stacked end-to-end and held in tight physically arrangement with one another using a sleeve 24 (e.g., seen in FIGS. 3 and 5). Additionally, the first filtration segment 20a comprising the single sheet of non-woven material may be secured over the second filtration segment 20b using the sleeve 24. In this manner, the first, second, and third filtration segments 20a, 20b, and 20c may be easily replaced as a single assembly.

Similar to that referenced above, any suitable sealing system may be utilized keep the oil passing through the respective filter element. Additionally, to enhance the flow through the filter, certain configurations may place a pressure on the oil (or other fluid being filtered). An suitable device may be utilized for such pressure.

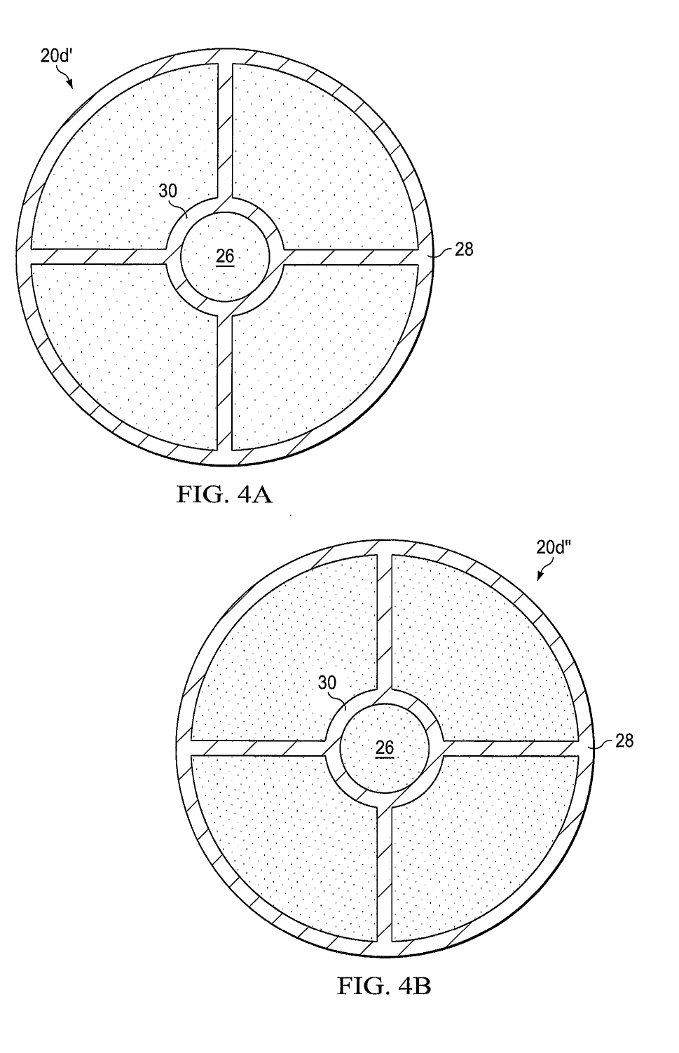

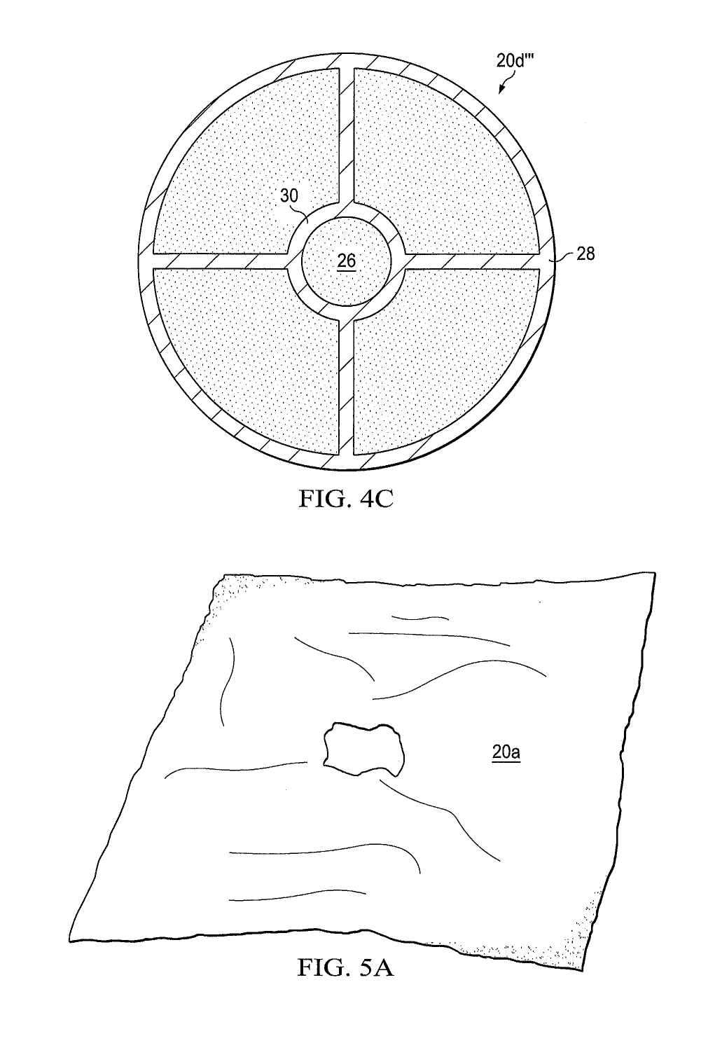

FIGS. 4A, 4B, and 4C illustrate particular details of the fourth filtration segment 20d that may be used with the oil filtration system according to embodiments of the present disclosure. In general, the fourth filtration segment 20d generally includes a single sheet of non-woven material that has the highest filtration density of any of the filtration segments for filtering the smallest particles from the oil. Although described as non-woven in this configuration, in other configurations the filtration segment 20d may be woven. A variety of nano-materials should become apparent to one of ordinary skill in the art after review of this specification.

The non-woven material forming the fourth filtration segment 20d has a disk-like shape with a centrally located hole 26 that is concentric with the hole in the second and third filtration segments 20b and 20c. The centrally located hole may generally correspond to the bypass described with reference to FIG. 2. The fourth filtration segment 20d has gaskets 28 and 30 configured along its outer periphery and inner periphery for sealing or inhibiting the flow path of the oil from bypassing the first, second, and third filtration segments (20a, 20b, and 20c). Although gaskets 28 and 30 are shown, in other configuration, other sealing mechanisms may be utilized. For example, the filtration segments 20d may include a sleeve on the inner portions that annularly travels up, for example, the conduit in the center of the flow path shown in FIG. 2. Similarly, a sleeve may also travel on the outer portions of the filtration segment 20d upward along the housing to insure that fluid or oil does not bypass the filtration segment 20d.

In particular embodiments, multiple filtration segments 20d may be stacked on top of one another. Additionally, in configurations that utilize dual or more passes as described above, the filtration segment 20d may have a larger inner hole, which accounts for both the first bypass and then subsequent passes through a different annular container. In such configuration with multiple passes, different diameter filtration segments 20d with different diameter holes may be placed in different annular segments.

In one embodiment, the fourth filtration segment 20d is separately replaceable from the assembly formed by the fist, second, and third filtration segments. For example, in particular configurations, the housing 10 may be designed for a filter that integrally includes filtration segments 20a, 20b, and 20c. Filter 20d thus becomes an add-on. In such a configuration, the filtration segment 20d is designed to not disturb the standard operations, but rather enhance the level of filtration. In such a configuration, the gaskets or other sealing mechanisms may complement the existing designs of the housing 12 to insure that the fluid or oil travels through the filtration segments 20d. Thus, in particular embodiments, filtration segment 20d may be seen as an additional layer of filtration to a current design. Where the current design includes one layer of filtration, the filtration segment 20d makes a two layer system. Where the current design includes two layer of filtration (e.g. FIG. 3), the filtration segment 20d makes it a three layer system and so on.

In another embodiment, the fourth filtration segment 20d is bonded to the third filtration segment 20c using a suitable bonding technique including, but not limited to, thermal bonding, such that the first, second, third, and fourth filtration segments forms a single replaceable assembly.

The fourth filtration segment 20d may have any of multiple filtration density levels to suit the user's needs. As shown, the fourth filtration segment 20d′ (FIG. 3A) has a filtration density of 2.0 microns. That is, the fourth filtration segment 20d′ may trap dirt or debris having a diameter of 2.0 microns or larger. Also as shown, the fourth filtration segment 20d″ and 20d′″ (FIG. 3B and 3C) may have a filtration density of 1.5 and 1.0 microns, respectively. In yet other configurations, a filtration density of 0.5 microns may be utilized.

Given the differing types of fourth filtration segments, a user may select a particular type that is optimized to his or her needs. For example, a user operating an engine in a very dirty environment may select a fourth filtration segment 20d′ having a 2.0 micron mesh size that is optimized to filter larger quantities of suspended particles. Conversely, the user operating an engine in a normal environment may select either fourth filtration segments 20d″ or 20d′″ (1.5 or 1.0 micron version) for enhanced filtering of the oil used by the engine.

In operation, the user may select a fourth filtration segment 20d that is ideally suited to his or her particular needs. If the fourth filtration segment 20d is integrally formed with the other filtration segments, the assembly may be placed in the housing as a single unit. On the other hand, if the fourth filtration segment 20d is provided as a separately replaceable unit, the selected fourth filtration segment 20d may then be placed in the housing followed by the assembly formed by the first, second, and third filtration segments. On a periodic, ongoing basis, the lid of the housing may be removed for inspection of both the assembly and the fourth filtration segment 20d to determine whether or not either one or both are to be replaced. In some cases, only the assembly formed by the first, second, and third filtration segments are to be replaced. In another case, only the fourth filtration assembly 20d is to be replaced. In yet another case, both the assembly and the fourth filtration segment 20d is to be replaced.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A bypass oil filter comprising:
a housing having an inlet and an outlet and configured to provide a flow path for oil from the inlet to the outlet; and
a filtration element comprising a plurality of filtration segments arranged in series configuration with one another along the flow path, each filtration segment having a filtering density that is greater than the density of another filtration segment upstream along the flow path.

2. The bypass oil filter of claim 1, wherein the filtration segments comprises a first, a second, a third, and a fourth filtration segments in which a first filtration segment has the lowest filtration density and the fourth filtration segment has the highest filtration density.

3. The bypass oil filter of claim 2, wherein the first, second, and third filtration segments are integrally formed as a single replaceable unit.

4. The bypass oil filter of claim 3, wherein the fourth filtration segment is integrally formed with the first, second, and third filtration segments.

5. The bypass oil filter of claim 3, wherein the fourth filtration segment is independently replaceable from the first, second, and third filtration segments.

6. The bypass oil filter of claim 2, wherein the fourth filtration segment has a filtration density of a at least one of a 1.0 micron density, and 1.5 micron density, and a 2.0 micron density.
